(19) United States
(12) Patent Application Publication
(10) Pub. No.: US 2015/0207972 A1
(43) Pub. Date: Jul. 23, 2015

(54) IMAGE ACQUISITION APPARATUS

(71) Applicant: CANON KABUSHIKI KAISHA, Tokyo (JP)

(72) Inventors: Kazuhiko Kajiyama, Utsunomiya-shi (JP); Yuji Katashiba, Kawasaki-shi (JP)

(21) Appl. No.: 14/592,419

(22) Filed: Jan. 8, 2015

(30) Foreign Application Priority Data
Jan. 20, 2014 (JP) 2014-007361

(51) Int. Cl. H04N 5/238; H04N 5/225; G03B 13/36

(52) U.S. Cl. CPC H04N 5/238; G03B 13/36; H04N 5/2254

(57) ABSTRACT

The image acquisition apparatus includes an imaging optical system configured to form an image of an object, multiple image sensors each configured to capture an image of the object through the imaging optical system, multiple variable angle prisms disposed between the imaging optical system and the image sensors, and the variable angle prisms each being paired with one of the image sensors. A controller is configured to control each variable angle prism to correct defocus of the imaging optical system on the image sensor paired with that variable angle prism.

### BACKGROUND OF THE INVENTION

1. Field of the Invention

The present invention relates to an image acquisition apparatus suitable for acquiring image data of, for example, a pathological sample.

2. Description of the Related Art

In a pathological examination, an image acquiring system is proposed which acquires image data by image capturing of a pathological specimen (sample) through an image acquisition apparatus and which displays the image data on a display unit for observation. When such an image acquisition apparatus is used to acquire image data of a sample that is larger than a field of view of an objective optical system, performing multiple times the image capturing of the sample or performing scanning thereof with moving the sample in a horizontal direction is required. Therefore, in order to shorten a time duration for acquiring the image data of the entire sample, an objective optical system having a large field of view (that is, a large image capturing area) is required. Moreover, observation of the sample requires the objective optical system to have, in addition to the large image capturing area, a high resolution in a visible light range.

The high resolution can be obtained by increasing a numerical aperture (NA) of the objective optical system. However, a larger NA decreases a depth of focus of the objective optical system. Moreover, when the sample has a surface uneven in a depth direction, an image thereof formed through the objective optical system has an uneven shape. Accordingly, the objective optical system having the high resolution and the large image capturing area may provide a defocused part in the image capturing area.

Japanese Patent Laid-open No. 2007-208775 discloses an image capturing apparatus capable of correcting field curvature of its image capturing lens by deforming a shape of its image capturing plane. This image capturing apparatus moves multiple photoelectric conversion elements independently so as to deform the image capturing plane depending on the field curvature. Japanese Translation of PCT International Application Publication No. 2001-507258 discloses an apparatus capable of correcting distortion of a wavefront by using a deformable mirror. This apparatus deforms the mirror based on a measured value of wave aberration of an eye so as to correct that aberration.

The image capturing apparatus disclosed in Japanese Patent Laid-open No. 2007-208775 requires an electric circuit for reading out signals from the photoelectric conversion element and a drive circuit for deforming the image capturing plane. In addition, this apparatus further requires, when cooling the photoelectric conversion element for noise reduction of image data, a cooling mechanism using a temperature controlling element, a cooling electric circuit or the like. Thus, particularly when providing the drive circuit to each of the photoelectric conversion elements, it is difficult to provide a space for placing the cooling mechanism for each of the photoelectric conversion element in addition to the drive circuit. Moreover, since focus adjustment with respect to the uneven surface of the sample requires a larger deformation of the image capturing plane, providing the drive circuit that enables a sufficient deformation in such a configuration requires a larger space. Therefore, such an image capturing apparatus disclosed in Japanese Patent Laid-open No. 2007-208775 cannot provide high quality (low noise) image data by producing an in-focus state for an entire range of a large image capturing area.

Furthermore, the apparatus disclosed in Japanese Translation of PCT International Application Publication No. 2001-507258 includes a mechanism that adjusts the wavefront. However, since the adjustment thereof is performed at a pupil position of its optical system, it is impossible to apply such a mechanism without change to an image acquisition apparatus so as to correct a defocus amount distribution with respect to the uneven sample in the image capturing area. In addition, focus adjustment at an image plane where the image of the sample is formed requires a larger drive amount of the mirror than that in the aberration correction. Therefore, such an apparatus disclosed in Japanese Translation of PCT International Application Publication No. 2001-507258 cannot achieve a sufficient in-focus state for the entire range of the large image capturing area.

### SUMMARY OF THE INVENTION

The present invention provides an image acquisition apparatus having a simple configuration and capable of focusing on an entire range of a large image capturing area.

The present invention provides as an aspect thereof an image acquisition apparatus including an imaging optical system configured to form an image of an object, multiple image sensors each configured to capture an image of the object through the imaging optical system, multiple variable angle prisms disposed between the imaging optical system and the image sensors, the variable angle prisms each being paired with one of the image sensors, and a controller configured to control each variable angle prism to correct defocus of the imaging optical system on the image sensor paired with that variable angle prism.

Further features of the present invention will become apparent from the following description of exemplary embodiments with reference to the attached drawings.

### BRIEF DESCRIPTION OF THE DRAWINGS

FIG. 1 is a block diagram of a configuration of an image acquisition system including an image acquisition apparatus of Embodiment 1 of the present invention.

FIGS. 2A and 2B illustrate s focus adjustment method using a variable angle prism in Embodiment 1.

FIGS. 3A and 3B illustrate an image sensor and an image capturing method in Embodiment 1.

FIG. 4 illustrates a configuration of an objective optical system of Embodiment 2 of the present invention.

### DESCRIPTION OF THE EMBODIMENTS

Exemplary embodiments of the present invention will be described below with reference to the accompanied drawings.

### Embodiment 1

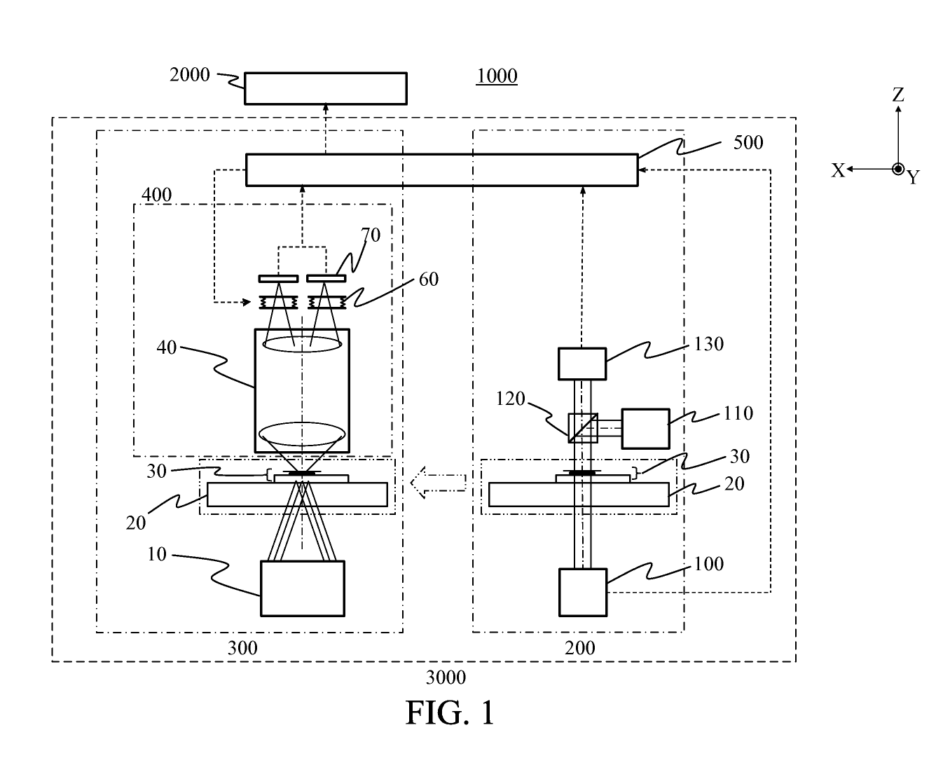

FIG. 1 illustrates a configuration of an image acquisition system 1000 of a first embodiment (Embodiment 1) of the present invention. The image acquisition system 1000 includes an image acquisition apparatus 3000 that acquires an image of a sample and an image display unit 2000 that displays the acquired image.

The image acquisition apparatus 3000 includes a measurer 200 that measures a prepared slide 30 including the sample, and a main image capturing unit 300 that performs image capturing of the prepared slide 30. The image acquisition apparatus 3000 further includes an image processor/controller 500 that controls the measurer 200 and the main image capturing unit 300 and processes image data acquired through the image capturing.

Description will hereinafter be made of an image acquisition procedure in the image acquisition apparatus 3000 of this embodiment. First, the prepared slide 30 including the sample is held on an image capturing stage 20 and placed in the measurer 200. Light from a measurement light source 110 is deflected through a beam splitter 120 and reaches the prepared slide 30. Light transmitted through the prepared slide enters an XY position measurement sensor 100 that measures, for example, a size and a position in X and Y directions of the sample in the prepared slide 30. The sensor 100 transfers the measurement data to the image processor/controller 500. The XY position measurement sensor 100 may be, for example, a CCD camera.

On the other hand, light reflected at the prepared slide 30 is transmitted through the beam splitter 120 and enters a Z-directional shape measurement sensor 130. The Z-directional shape measurement sensor 130 measures a position in a Z direction (Z-directional shape) of the sample in the prepared slide 30 at each XY position and transfers the measurement data to the image processor/controller 500. The Z-directional shape measurement sensor 130 may be, for example, a Shack Hartman sensor.

The image processor/controller 500 stores this transferred measurement data (data of the position, the size and the Z-directional shape of the sample) of the prepared slide 30 in a memory (not illustrated). The measurer 200 is not limited to such a configuration; for example, the measurer 200 may measure the positions in the X and Y directions and the Z-directional shape at mutually different positions by using mutually different light sources.

When the measurement is finished, the image capturing stage 20 holding the prepared slide 30 is moved from the measurer 200 to the main image capturing unit 300.

In the main image capturing unit 300, light emitted from a light source (not illustrated) enters an illumination optical system 10 that uniformly illuminates the prepared slide 30 with the light. The light emitted from the light source may be, for example, visible light having a wavelength from 400 nm to 700 nm.

Light from the sample in the prepared slide enters an objective optical system 400. The objective optical system 400 in this embodiment includes a (single) imaging optical system 40 and multiple variable angle prisms 60. The light from the sample forms images of the sample (object images) near the respective variable angle prisms 60 through the imaging optical system 40. The lights forming the images of the sample are respectively deflected by the variable angle prisms 60, and as a result, the images of the sample are respectively formed on image capturing planes of multiple image sensors 70 (hereinafter, also expressed as “on the image sensors 70”) arranged along an image plane of the imaging optical system 40. Each of the variable angle prisms is provided so as to be paired with one of the respective image sensors 70.

Each variable angle prism 60 used in this embodiment includes two light transmissive parallel plates and a stretchable member (accordion member) connecting these plates, which provides a sealed inner space filled with transmissive liquid. At least one of the two parallel plates is tilted with respect to an optical axis of the imaging optical system 40 to change a relative tilt (apex angle) between the two parallel plates, which makes it possible to provide an optical effect depending on the apex angle. The apex angles of the variable angle prisms 60 are controlled based on the measurement data by the image processor/controller 500 serving as a prism controller. For example, it is desired to acquire, by measurement, defocus amounts of the imaging optical system 40 different for the respective image sensors 70 and to control the apex angles of the variable angle prisms 60, independently of each other, depending on the respective defocus amounts. This enables acquiring in-focus states on all the image sensors 70 over an entire range of an image capturing area formed by the imaging optical system 40. This will be described in detail later.

In this embodiment, description is made of the case where the imaging optical system 40 images only one time, but an imaging optical system may be used which images multiple times to form images of the sample on the image sensors 70. For example, a catadioptric system that forms an intermediate image in forming images of the sample at a position near the respective variable angle prisms 60 may be used. In other words, the objective optical system 400 is only required to have a configuration that causes the variable angle prisms 60 to deflect lights at a position near a final imaging position of the imaging optical system 40 and then causes the lights to image on the image sensors 70, but has no limitation for number of times of imaging.

As described later, the variable angle prism 60 is desirably disposed as “near” the imaging position of the imaging optical system 40 as possible, but may disposed anywhere between the imaging optical system 40 (an exit surface thereof) and the image sensors 70.

Each image sensor 70 captures the image of the sample formed on its image capturing plane and outputs an image capturing signal. The image processor/controller 500 when serving as an image processor performs various processes on the image capturing signal to produce image data. The image processor/controller 500 when serving as an image outputter converts the image data into data of a data format appropriate for display on the image display unit 2000 and outputs this converted image data to the image display unit 2000, thereby causing the image display unit 2000 to display a displaying image of the sample.

The image processor/controller 500 corrects aberration which is not corrected by the objective optical system 400 and performs a process to join the multiple acquired image data to one another to produce a single image data.

Next, description will be made of a focus adjustment (defocus correction) of the imaging optical system 40 by the variable angle prisms 60.

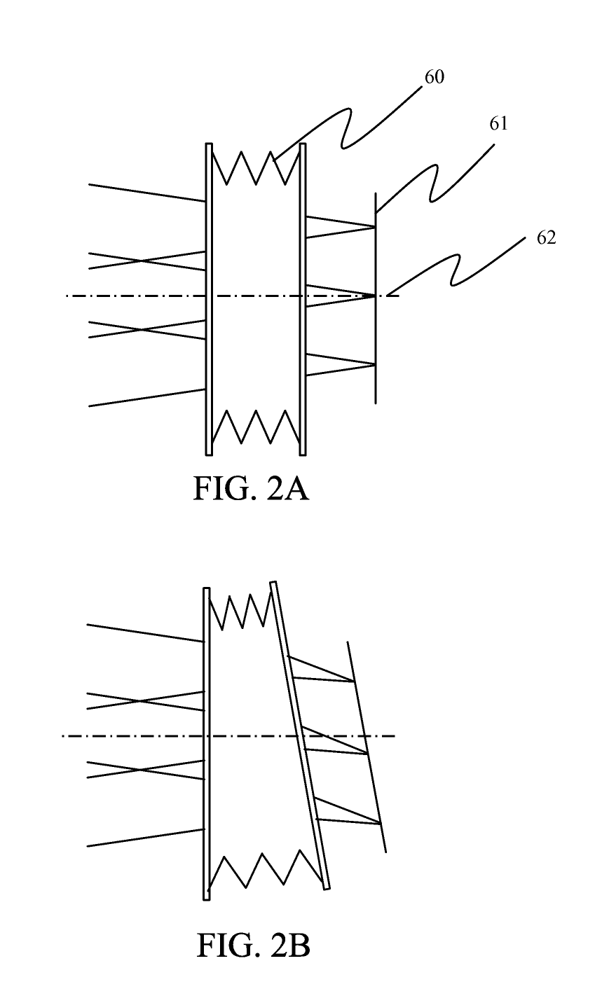

FIGS. 2A and 2B illustrate a relation between a position of an imaging point (imaging plane 61) of the imaging optical system 40 and the apex angle of the variable angle prism 60. FIG. 2A illustrates a state in which the sample is even, which eliminates need for adjusting the imaging surface 61 by the variable angle prism 60. FIG. 2B illustrates a state in which the imaging plane 61 is tilted by the variable angle prism 60 being tilted from the state illustrated in FIG. 2A with respect to a central axis (axis parallel to the optical axis of the imaging optical system 40) 62 of the image sensor 70. In practice, the imaging plane 61 tilted due to unevenness of the sample is adjusted by the variable angle prism 60 so that the imaging plane 61 and the central axis 62 are orthogonal to each other. However in FIG. 2B, for description, the imaging plane is tilted by the variable angle prism 60 from the state illustrated in FIG. 2A which needs no adjustment.

As understood from FIG. 2B, the variable angle prism 60 not only can tilt the imaging plane 61, but also shifts an image with respect to the central axis 62 of the image sensor 70. This image shift is utilized when a variable angle prism is used for image stabilizing to prevent image blur due to, for example, shaking of a video lens due to user's hand jiggling. However, this image shift is not desired in the image acquisition system in this embodiment for acquiring image data of a pathological sample. This is because an error is generated in the process of joining the multiple image data to produce the single image data.

In addition to the image shift, the variable angle prism 60 causes chromatic aberration of magnification due to its prismatic effect. In order to prevent such image shift and chromatic aberration of magnification, the variable angle prism 60 is desirably disposed as near the imaging plane 61 as possible. The remaining image shift and chromatic aberration of magnification that cannot be prevented in this manner are desirably corrected by estimating amounts of the image shift and chromatic aberration of magnification based on a deflection angle of light by the variable angle prism 60 and by performing image processing based on the estimation results by the image processor/controller 500. Thus, the image processor/controller 500 desirably has a function as an image processing means to correct an image component corresponding to the chromatic aberration of magnification generated in the variable angle prism 60.

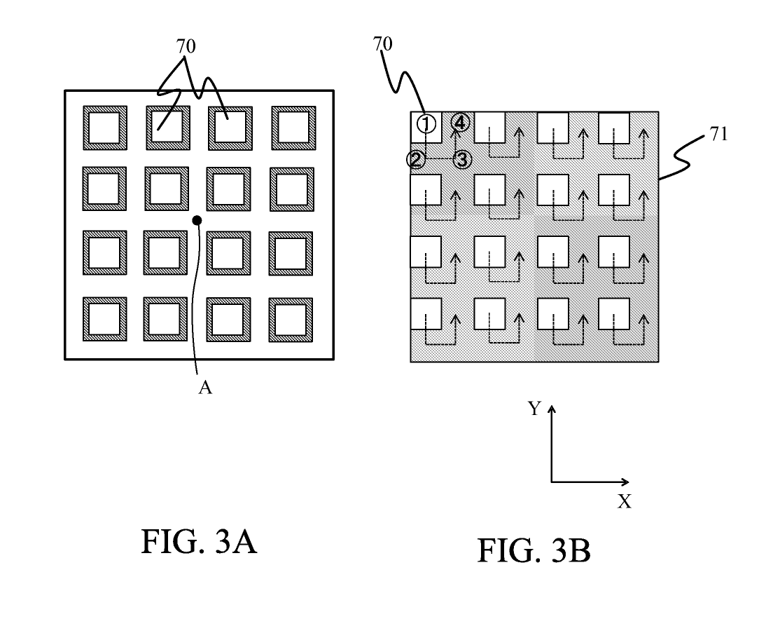

FIG. 3A illustrates an exemplary arrangement of the image sensors 70 viewed from a direction of the optical axis (optical axis direction) of the imaging optical system 40. The image sensors 70 are two-dimensionally arranged around the optical axis of the imaging optical system 40 in a plane parallel to the image plane of the imaging optical system 40. Letter A in FIG. 3A shows the optical axis of the imaging optical system 40.

As illustrated in FIG. 1, the variable angle prisms 60 are disposed closer to the imaging optical system 40 in the optical axis direction than the image sensors 70. Each of the variable angle prisms 60 is paired with one of the image sensors 70. FIG. 3B illustrates, with arrows, movement of relative positions of the image sensors 70 and the prepared slide 30 at image capturing. In FIGS. 3A and 3B, an order of performing image capturing is illustrated for one image sensor 70 with circled numbers 1 to 4 (hereinafter denoted by numbers in parentheses).

With the arrangement in FIG. 3A, as illustrated in FIG. 3B, the image sensors 70 performs image capturing four times with movement thereof with respect to the prepared slide 30 three times in a negative Y direction (2), a positive X direction (3) and a positive Y direction (4). Four images acquired by the image capturing four times are joined together to acquire a single image data of an image capturing area 71.

When the image sensors 70 thus perform the image capturing multiple times, the apex angles of the variable angle prism 60 are set at each image capturing. At each image capturing, the apex angle of each variable angle prism 60 is controlled depending on a defocus amount on the image sensor 70 paired with that variable angle prism 60. This configuration enables acquiring, even when a large sample has an uneven shape in the Z direction, in-focus states for all the image sensors 70 at each image capturing.

An optimum value of the apex angle of each variable angle prism 60 can be calculated from the Z-direction position data of the sample previously acquired at each XY position by the measurer 200 by, for example, a least-squares method.

The configuration described above enables focus adjustment for each of the multiple image sensors (that is, for each angle of view of the imaging optical system 40) by each of the multiple variable angle prisms 60 provided so as to be paired with the respective image sensors 70. This configuration enables providing, even when the sample has an uneven shape, in-focus states for all the image sensors 70 in the entire range of the image capturing area by controlling the variable angle prisms 60 depending on the uneven shape. Thus, this embodiment can realize an image acquisition apparatus having a simple configuration and a high resolution over an entire range of a large image capturing area.

### Embodiment 2

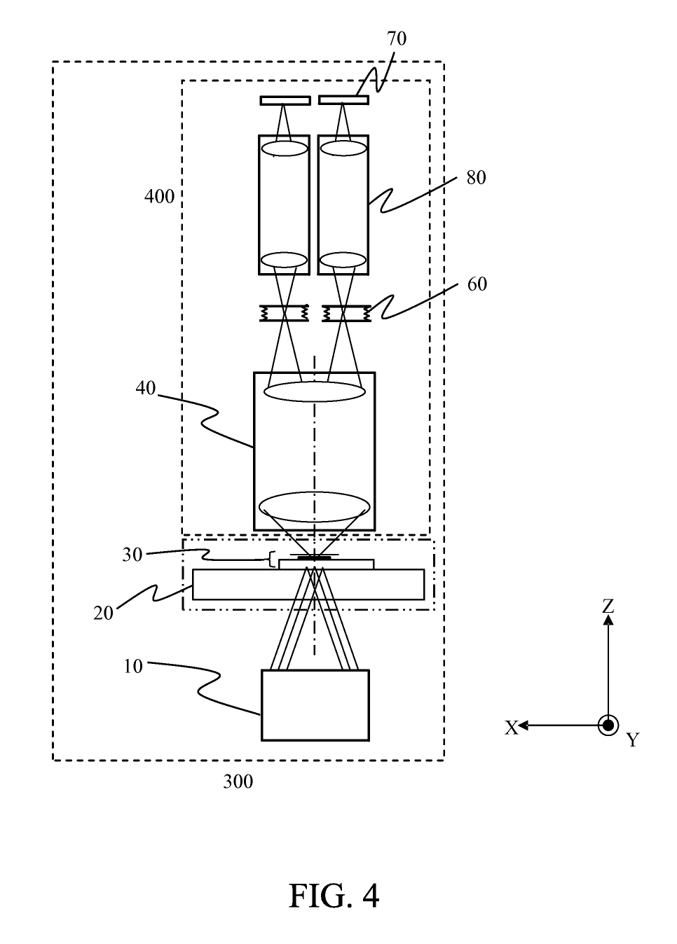

Next, description will be made of a second embodiment (Embodiment 2) of the present invention with reference to FIG. 4. In this embodiment, the variable angle prisms 60 are arranged at the imaging position (or a position that can be regarded as the imaging position) of the imaging optical system 40. In this embodiment, light from each variable angle prism 60 is reimaged, through a second imaging optical system (another imaging optical system) 80 provided for each of the image sensors 70, on the image capturing plane of the image sensor 70 paired with that variable angle prism 60. Components identical to those in Embodiment are denoted by same reference numerals as those in Embodiment 1, and description thereof will be omitted.

In this embodiment, unlike in Embodiment 1, the variable angle prism 60 is arranged at the imaging position of the imaging optical system 40 or the position substantially coinciding with the imaging position. This arrangement can prevent the image shift and the chromatic aberration of magnification described in Embodiment 1. In the objective optical system 400 in this embodiment, the variable angle prisms 60 and the image sensors 70 are arranged at spatially mutually different positions, which allows, for example, drive mechanisms of the variable angle prisms 60 and electric circuits and temperature adjustment mechanisms for the image sensors 70 to be arranged with a high degree of freedom.

When the tilt of the variable angle prism 60 with respect to the optical axis is changed depending on the uneven shape of the sample, a travelling direction of the light is also changed due to the apex angle of the variable angle prism 60. Therefore, the tilt of the variable angle prism 60 is desirably controlled so that the light travels within an optical path of the second imaging optical system 80, by providing an appropriate NA to the second imaging optical system 80.

Although Embodiment 1 described the case where the apex angles of the variable angle prisms 60 are controlled so as to provide the in-focus state over the entire range of the image capturing area, drive of the image sensors 70 by an image sensor drive mechanism may be combine therewith. Specifically, a tilt component of defocus in the image capturing area is adjusted by controlling the apex angle of the variable angle prism 60, and a uniform component of the defocus in the optical axis direction in the image capturing area may be adjusted by moving the image sensor 70 in the optical axis direction.

Moreover, although Embodiment 1 described the case where sixteen image sensors 70 are arranged and the image capturing is performed four times, any number of the image sensors 70 other than sixteen may be arranged and the image capturing may be performed any number of times. In such a case, the number of the variable angle prisms 60 and the number of the second imaging optical systems 80 are changed corresponding to the number of the image sensors, thereby providing in-focus states for all the image sensors as in Embodiment 1. The number of the image sensors and the number of times of the image capturing may be determined as appropriate depending on a degree of the unevenness in the Z (depth) direction in the surface of the sample as an image capturing target, and a spatial constraint on arrangement of the image sensors and the variable angle prisms.

Furthermore, the above embodiments described the case of performing a step-by-step image capturing across a large image capturing area. However, in a case of performing scanning of the image capturing area across the large image capturing area, an image acquisition apparatus having the configuration described above is also applicable. In addition, although the above embodiments described the case where the image sensors 70 are moved with respect to the prepared slide 30, the prepared slide 30 may be moved with respect to the image sensors 70 along arrows in FIG. 3B showing relative movements between the prepared slide 30 and the image sensors 70.

As described above, each of the embodiments provides the multiple image sensors 70 for the single imaging optical system 40 and performs the focus adjustment for each image sensor (each angle of view) by using the variable angle prism 60 provided for each image sensor 70, which enables providing in-focus states over the entire range of the image capturing area. Thus, each of the embodiments can realize an image acquisition apparatus having a simple configuration and a high resolution over an entire range of a large image capturing area.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-007361, filed on Jan. 20, 2014, which is hereby incorporated by reference wherein in its entirety.

What is claimed is:

1. An image acquisition apparatus comprising:
an imaging optical system configured to form an image of an object;
multiple image sensors each configured to capture an image of the object through the imaging optical system;
multiple variable angle prisms disposed between the imaging optical system and the image sensors, the variable angle prisms each being paired with one of the image sensors; and
a controller configured to control each variable angle prism to correct defocus of the imaging optical system on the image sensor paired with that variable angle prism.

2. An image acquisition apparatus according to claim 1, wherein the controller is configured to control the variable angle prisms depending on a shape of the object.

3. An image acquisition apparatus according to claim 1, wherein the controller is configured to control each variable angle prism depending on a defocus amount of the imaging optical system on the image sensor paired with that variable angle prism.

4. An image acquisition apparatus according to claim 3, wherein the controller is configured to control the respective variable angle prisms independently of one another, depending on the defocus amounts of the imaging optical system on the image sensors paired with the respective variable angle prisms.

5. An image acquisition apparatus according to claim 1, further comprising a drive mechanism configured to move the image sensors independently of one another in an optical axis direction of the imaging optical system.

6. An image acquisition apparatus according to claim 1, wherein the image sensors and the variable angle prisms are two-dimensionally arranged around an optical axis of the imaging optical system.

7. An image acquisition apparatus according to claim 1, wherein:
the apparatus is configured to perform image capturing multiple times while relatively moving the object and the image sensors in a plane parallel to an image plane of the imaging optical system, and
the apparatus is configured to change, at each image capturing, tilt directions of the variable angle prisms.

8. An image acquisition apparatus according to claim 1, wherein another imaging optical system different from the imaging optical system is disposed between each variable angle prism and the image sensor paired with that variable angle prism.

9. An image acquisition apparatus according to claim 1, further comprising an image processor configured to correct, in image data acquired using output from each image sensor, an image component caused by chromatic aberration of magnification generated in the variable angle prism paired with that image sensor.

10. An image acquisition apparatus according to claim 1, further comprising an image outputter configured to display image data acquired using outputs from the image sensors on a display unit.
